(19) United States
(12) Patent Application Publication
(10) Pub. No.: US 2003/0112123 A1
(43) Pub. Date: Jun. 19, 2003

(54) Method and apparatus for providing a programmable gate security system

(76) Inventors: Wayne C. Hom, Rancho Santa Margarita, CA (US); Daniel Perez, Foothills Ranch, CA (US)

Correspondence Address: LEVIN & HAWES, P O BOX 4140, LAGUNA BEACH, CA, 92652

(21) Appl. No.: 10/027,932

(22) Filed: Dec. 19, 2001

(51) Int. Cl. G05B 19/00

(52) U.S. Cl. 340/5.65; 340/5.7; 340/5.21

(57) ABSTRACT

An apparatus for activating and reprogramming various features of a security system that relies on a read/write chip that inserts into a socket connected to the control unit of the security system. Depending on the activation codes written onto the chip, when the chip is inserted into its socket, it activates or deactivates various features and parameters of the system. The speed the gate opens and closes at, how long it remains open etc. can be varied. Additionally, the chip can be used to activate advanced features of the system built into the system when originally installed. Thus, if a customer desires to upgrade to advanced features of the system this avoids having to install additional features since they having already been built into the system and are activated by insertion of a chip with the appropriate code.

### FIELD OF THE INVENTION

The present invention relates to security systems for limiting of access to a restricted area. More particularly it relates to a system and method of reprogramming such systems.

### BACKGROUND OF THE INVENTION

Gated security systems typically consist of at least one gate for limited access into a secure area, the operation of which is regulated by a gate controller. In order to enter the secure area protected by the security system an individual typically must enter an access code by means of a keypad attached to the gate controller or by use of an infrared (IR) or radio frequency (RF) transmitter or transceiver that communicates with the gate controller. Once the controller recognizes the access code transmitted by the transmitter or transceiver it will open the gate and allow access to the restricted area. Actual operation of the gate can vary depending on the sophistication of the security system. Very simple systems preset the opening and closing speed of the gate based on the assumption of how fast a typical vehicle might take to move through the open gate and move beyond a point where the closing gate might accidentally hit the vehicle if it closed to soon. More advanced systems include sensors in and around the gate area with which the system can determine the position of the vehicle and only close the gate after the system determines the individual has passed beyond the area of movement of the gate. These systems might also have additional features available such as an anti-tailgating option that provides for a quick closing the gate after passage of the authorized vehicle. In these more sophisticated systems on installation they tend to have variety of different features and capabilities from which the property owner can chose.

However, currently available security systems tend to be uniquely designed or tailored to the specifications set on installation. Once installed, gate security systems tend to have limited flexibility for upgrading or change of their operational characteristics. Even in gate security systems that are capable of being upgraded, to do so usually requires a trained technician who must go to the location of the gate security system and install the upgraded system. The technician often has to replace circuit boards with ones that have the features specified by the upgrade. Additionally, to change operational parameters, i.e. the timing of the opening and closing of the gate, a technician has to service the gate controller and reset switches or timing devices on the gate controller. Not only does this generate substantial added expense, it also creates a potential security problem in that an unauthorized individual that gains access to the unit can reset the operational parameters of the unit and thereby breach systems security. Even if all a property owner wants to do is change the access codes for those authorized to enter the restricted area, a visit by an appropriately trained technician is necessary to make the changes to the access codes.

Most gate security systems are located outside and the climatic conditions can vary from the sub arctic with sub zero temperatures to tropical climates with hot and humid conditions. Thus, most gate security systems require a significant degree of ruggedness to function error free over many years.

Thus, what is needed is an economical and efficient method and system for upgrading a gate security system. What is also needed is a method and system that will also allow for an efficient and economical modification the operational parameters of a gate security system that is also rugged, durable and capable of functioning in a wide variety of climatic conditions.

### SUMMARY

Thus, it is an objective of the present invention to provide a system and method with which a security system can be economically, efficiently and quickly upgraded. It is a further objective of the present invention to provide a system and method that will also allow for the efficient, economical and quick changing of the operational parameters of a security system.

These and other objectives are accomplished by providing a reprogramable security system for limiting access to a protected area, the system including: a) a movable barrier for allowing access to a restricted area; b) a motor operatively attached to said barrier for opening and closing said barrier; c) a control system for controlling operation of said motor; d) a sensing system for sensing factors used by said control system for determining when to open and close said gate by activation of said motor; and e) an activation chip connectable to said control system wherein said chip can activate functions of said control system.

In a further aspect of the invention it provides a method for varying the operational parameters of a security system that includes the steps of: a)providing power to a security system; b) having the system look for an activation chip; c) reading by the system of codes on the chip; d) matching the code on the chip with a look up table of codes saved in a memory of the system; and e) activating features of the security system associated with the matched code.

### BRIEF DESCRIPTION OF THE DRAWINGS

The invention will be better understood by an examination of the following description, together with the accompanying drawings, in which:

FIG. 1 is a block diagram of the major functional components of the present invention;

FIG. 2 is bloc diagram of a version of the preferred embodiment of a gate controller of the present invention;

FIG. 2A is a schematic diagram of a swinging gate system with which the present invention can be used;

FIG. 2B is a schematic diagram of a sliding gate system with which the present invention can be used;

FIG. 3 is a view of a corner of a main circuit board of a gate controller of a preferred embodiment of the present invention;

FIG. 4 is a view of an activation chip of the present invention together with a daughter board of the present invention that attaches to the main board, the daughter board having a socket to connect the activation chip to the main board present invention;

FIG. 5 is a block diagram of the major functional parts of one version of a preferred embodiment of the activation chip of the present invention; and

FIG. 6 is a flow chart of one preferred embodiment of the method of the present invention.

### DETAILED DESCRIPTION OF THE PREFERRED EMBODIMENT

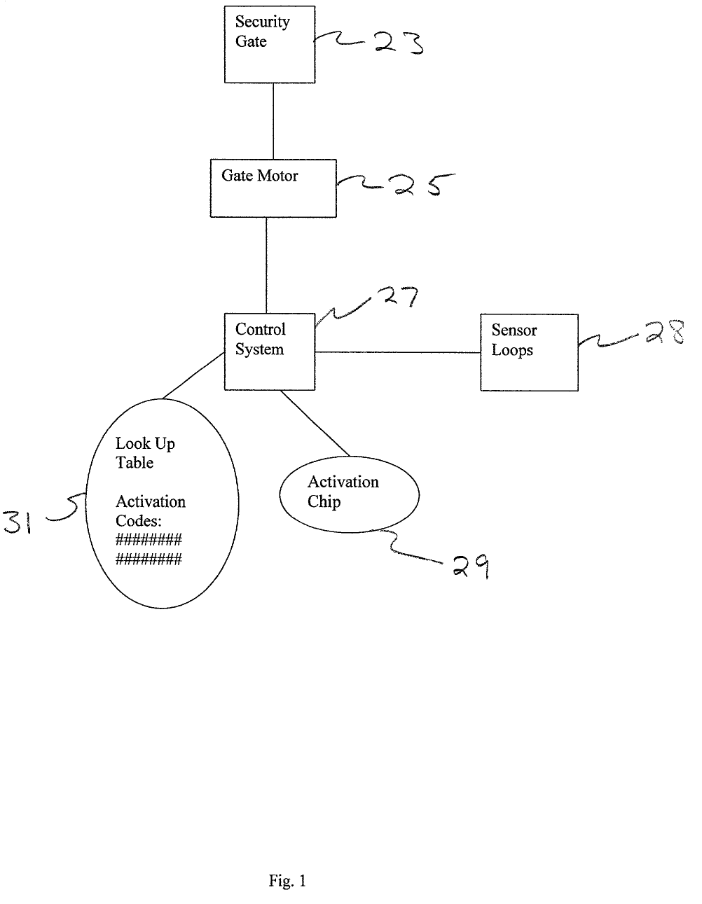

FIG. 1 is a block diagram of the overall functional parts of one preferred embodiment of the present invention. A security gate 23 is operatively connected to a gate motor 25 and in turn operation of the gate motor is controlled by control system 27. Control system 27, when an activation chip 29 is inserted, reads an activation code on chip 29 and then compares the code with a series of codes in a look up table 31. Look up table 31 has various codes each of which are associated with certain functions of the control system. When the control system 27 matches an activation code on look up table 31 with a code on activation chip 29 the particular features associated with that activation code are enabled. Thus, by changing the activation or enabling codes on the activation chip before insertion into the system, preprogrammed features of the system can be activated or deactivated. Additionally, with appropriate software in the system to respond to activation or enablement codes operational parameters of the system can be varied. These aspects will be discussed in more detail below after additional background information on gated security systems is reviewed.

The system in part makes decisions regarding its operation including the opening and closing of the gate 23 based on information obtained by the control system from sensor loops 28 which are strategically positioned around the gate. In one version of the preferred embodiment, the sensor loops 28 provide relevant information regarding the ambient magnetic field near the gate, which the system uses to determine if a vehicle is present and the vehicle's location with relation to the gate.

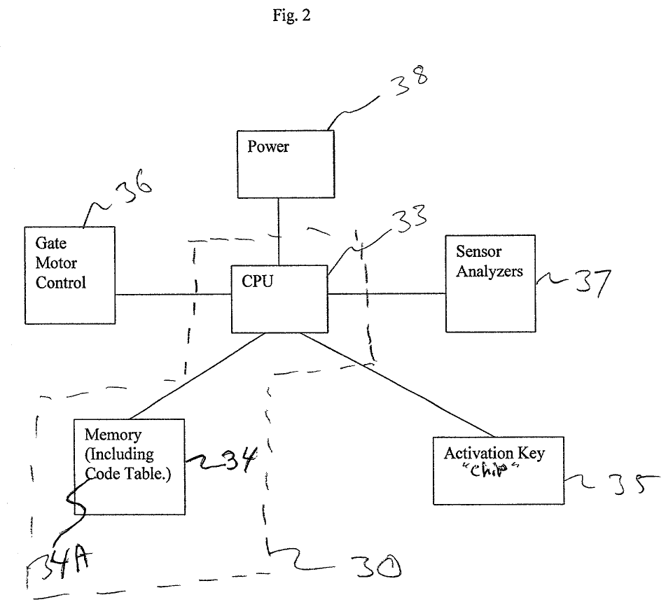

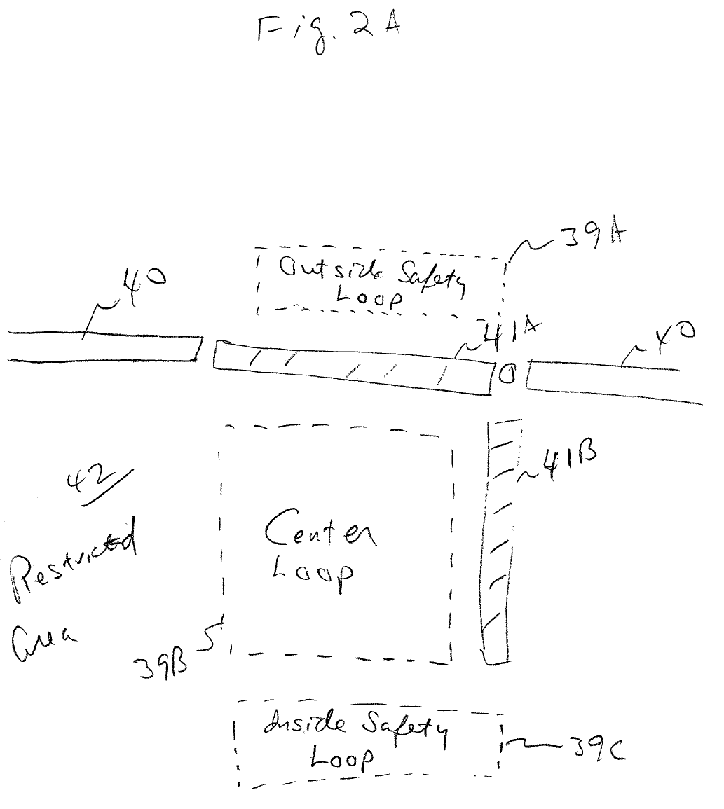

In one preferred embodiment control system 27 is a gate controller. FIG. 2 is a block diagram of one version of a gate controller 30 outlined with dotted lines. In FIG. 2 operation of the gate controller is controlled and coordinated by CPU 33. Memory 34 typically has the software that the CPU is executing. The memory would also include look up table or code table 34A. Based on the authorized codes provided by activation chip or key 35 CPU 33 would operate the gate motor control 36 according the parameters of the activation code. Naturally, the system has a power supply 38.

Decisions the CPU 33 makes regarding operation of the gate motor control will in part be based on information provided by sensor analyzers 37. In a swinging gate system the gate sensor analyzers 37 connect to safety sensor loops 39A, 39B and 39C (FIG. 2A). In the standard system loops 39A, 39B and 39C are wire sensors embedded in the ground and which sense changes in the ambient magnetic field above sensor 39A, 39B and 39C. Wall 40 encloses the restricted area 42 and gate 41 when opened allows access. Thus when a motor vehicle passes over one of the loops 39A, 39B and 39C the sensor analyzers detect it is present as a result of the changes in the magnetic fields above each sensor. When a vehicle arrives at the gate and moves over outside safety sensor 39A the system detects its presence through readings at the sensor analyzer attached to loop 39A. The person in the vehicle will transmit his or her authorization code by an IR or RF transmission or entering the code on a keypad connected to the system. This will initiate opening of gate 41 moving it from closed position 41A to open position 41B. As the vehicle move through the open gate 41B, center loop detector 39B senses the presence of the vehicle and in turn inside safety loop 39C detects the presence of the vehicle as it moves over loop 39C. Based on information provided by each loop and its associated sensor analyzer the system at all times can determine the precise location of the vehicle and operation of the gate can be precisely controlled.

The gate security system can be programmed for various operational patterns, such as delayed opening or closing of the gate. Additionally, anti-tailgating features can be incorporated into the system which would provide for a quick closing of the gate after passage of a vehicle with the appropriate authorization code and an unauthorized vehicle attempting to sneak in after passage of the authorized vehicle would be stopped by the quickly closing gate.

The sliding gate system of FIG. 2B works in a similar fashion to the swing gate system of FIG. 2A. However, there are differences that require programming the system for different operational parameters. In a sliding gate system only an outside safety loop 43A and an inside safety loop 43B is necessary. This is because sliding gate 44 slides out of the way and does not swing out over the roadway into the restricted area 42. Thus, opening and closing parameters and sensor readings vary significantly. With the system of the present invention, the gate controller can be programmed for both the swinging and sliding gate system and the appropriate programming for the swinging or sliding gate system can be enabled merely by inserting an activation chip with the appropriate activation code.

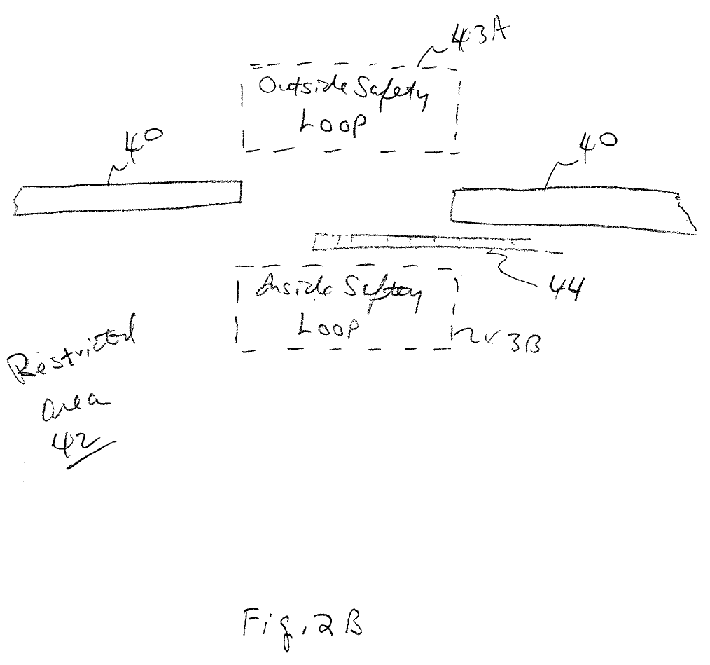

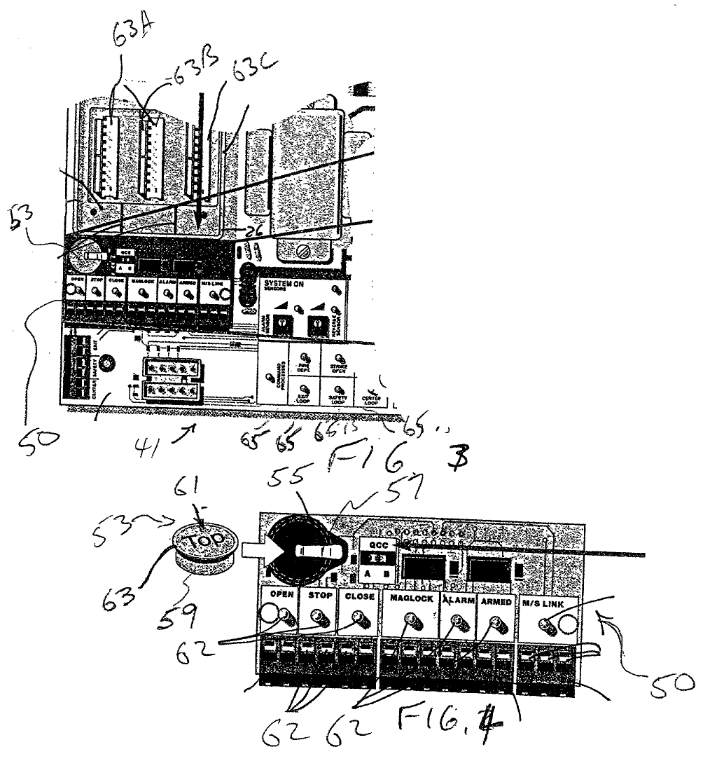

FIGS. 3 and 4 depict a physical implementation of the concept of the present invention on the circuit boards of a gate controller. FIG. 3 depicts a corner of a main gate controller motherboard 41. Attached to board 41 is daughter board 50. Daughter board 50 interconnects activation chip 53 into the system of the present invention. FIG. 4 depicts daughter board 50 removed from main board 41 with activation chip 53 removed from its socket 55. When activation chip 53 is placed in socket 55 clip 57 holds it in place. As depicted in FIG. 4, chip 53 is a wafer shaped metal clad device of small diameter and thickness. Cup shaped bottom 59 acts as the first electrical contact and circular plate top 61 acts as a second contact. Top 61 and bottom 59 are electrically insulated from each other by nonconductive ring 63. Thus when chip 53 is placed in socket 55 bottom 59 makes electrical contact with the inside of socket 55 and top 61 makes electrical contact with clip 57 to complete an electrical circuit and thus connect chip 53 into the circuitry of the system. The preceding is only a preferred embodiment of the activation chip of the present invention. Those skilled in the art once they have read and understand the concepts of the present invention as described herein will readily appreciate the fact that the design of the chip and the fashion in which it connects into the system of the gate controller can be significantly varied without departing from the practice of the present invention. This includes placing the functions of the daughter board on the main board etc.

In FIG. 4 daughter board 50 has indicator lights 62. In FIG. 3 connectors 63 receive controller modules containing electro-mechanical/electro-magnetic components that are associated with sensor loops 39A, 39B and 39C (FIG. 2A) or 43A and 43B (FIG. 2B). Main board 41 also has indicator lights 65 that provide status indication of the operation of the system.

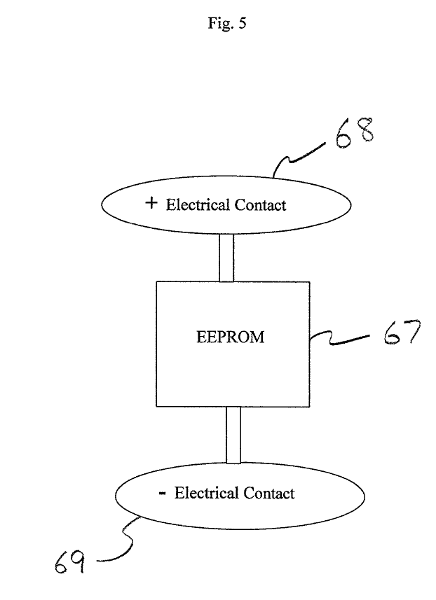

Chip 53 has its own internal read/write memory typically an erasable programmable memory (EEPROM) that allows for the writing of activation codes to the chip as well as being able to erase codes on the chip and rewrite new ones. The block diagram of FIG. 5 depicts one preferred embodiment off the essential parts of the activation chip which are an electrically erasable programmable read only memory, EEPROM, 67 and the electrical contacts 68 and 69. The memory of the EEPROM can be programmed by connecting it to a computer with appropriate software and electrical connections to the computer. Those skilled in the art once they have read and understand the concepts of the present invention should have no problem in conceptualizing a system that would include an appropriate EEPROM with which to enable the system of the present invention. A number of different systems that provide EEPROM's are currently available.

In the preferred embodiment of the present invention the activation chip is a Dallas Semiconductor iButton®. This type of chip is a 16 mm in diameter wafer shaped metal case. A depicted in FIG. 4 the two electrically isolated sides of the case 59 and 61 act as the electrical contacts. The iButton® which the present invention uses would be programmed, i.e. its memory would be programmed with a computer and appropriate software. One of the advantages of using this device as the activation chip is its adaptability to harsh environments. Most gate security systems are installed outdoors and have to be rugged enough to function in a wide variety of climatic conditions. These can vary from subzero environments to hot wet tropical environments.

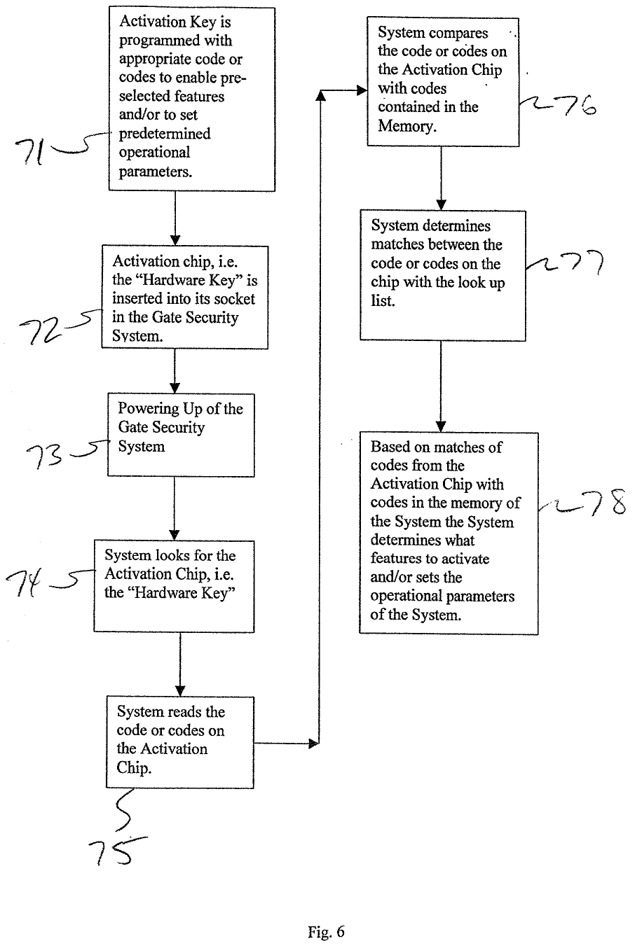

The method of the present invention thus entails programming the activation chip with the appropriate code or codes 71 (FIG. 6). Inserting the activation chip into the appropriate socket of the gate security system 72. The system upon being powered up 73 then looks for the activation chip 74 and upon finding it reads the code or codes on the activation chip 75. The system then compares the code or codes on the chip with the codes contained in memory 76. Upon reading and comparing the code or codes from the chip with the code or codes in the memory of the system it then determines what matches exist between those on the chip and in memory 78. Based on matches of codes on the chip with codes contained in memory of the system, the system determines what features to activate and/or what the operational parameters of the system should be set at.

One of the advantages of the present system is that only one master gate controller board or system has to be manufactured. This board or system would incorporate all operational variations of the system. Each of the variations would be enabled by the appropriate authorization codes. This thus eliminates the need to manufacture several different systems or boards that enable certain pre-selected features. Additionally, use of the activation chips allows for the selectively setting or resetting of the operational parameters of the gate security system. These will be discussed below in somewhat more detail, include the timing of opening and closing of the gate.

Another advantage is that security codes used to open the gate can be set and changed with the activation chips. Typically the gate security system requires that a person seeking entry through the gate enter a security code the system recognizes to prompt the system to open the gate and allow access. The code can be entered by a key pad provided adjacent to the gate or by an IR or RF transmitter or transceiver. The system upon keying in of the access code or receipt of transmission of an access code from the IR or RF device upon identifying the access code as an authorized one would open the gate to allow access. The activation chip can be programmed with the appropriate access codes and once inserted into its socket in the system would update the system as to the currently allowed access codes.

The present invention would also allow one overall board or system to be used with either sliding or swinging security gates. The operational characteristics of a swinging or sliding gate system differ significantly and each system generally requires its own separate system. However, the requirements of each have enough similarity that one overall system or board could be fabricated to work with both systems. The system would have programmed into it all of the parameters and features necessary for the proper operation of each system. Enablement of operation of the system with a swing or sliding gate system would depend on the authorization code written onto the activation chip inserted into the system.

The system or board could also be fabricated such that it will function with either a one or two gate system. In a one-gate system you generally might only be concerned with the speed at which the gate opens and closes and the time delays between opening and closing of the gate. In a two-gate system you would have to be concerned with opening and closing of each gate in a coordinated fashion to avoid entrapping a vehicle between the gates etc.

The system would also allow a customer to upgrade the system to a higher level of functionality without the need for replacing portions of the system or require a technician to install upgrade features or reset switches or other features on the boards of the system. All that would be necessary would be insertion of the appropriate activation chip with the appropriate enabling codes. For example the customer might want to enable an anti-tailgating feature of the system. Typically, after a security gate has opened to allow an authorized vehicle in there is a delay before the gate closes to allow the vehicle to pass through. Instead of having to have a technician service the system to change the closing parameters, insertion of the chip would allow for a reprogramming of the system based on the enabling or activation code written onto the chip. The manufacturer upon request of the customer would provide an activation chip with the appropriate code.

The system of the present invention could also include the option of insertion of an activation chip with a code that would enable a diagnostic mode. This would allow a technician servicing the unit to run diagnostic or other tests on the system to verify the system is operating properly or for trouble shooting system failures that may occur during operation. Use of such codes instead of placing switches on the board to enable a diagnostic or test mode would prevent others from tampering with the system.

While the invention has been particularly shown and described with reference to a preferred embodiment thereof, it will be understood by those skilled in the art that various changes in form and detail may be made to it without departing from the spirit and scope of the invention.

We claim:

1. A reprogramable security system for limiting access to a protected area comprising:
a) a movable barrier for allowing access to a restricted area;
b) a motor operatively attached to said barrier for opening and closing said barrier;
c) a control system for controlling operation of said motor;
d) an activation chip connectable to said control system wherein said chip can activate functions of said control system.

2. The security system of claim 1 further comprising a sensing system for sensing factors used by said control system for determining when to open and close said gate by activation of said motor.

3. The security system of claim 1 wherein activation of said functions further comprises varying the operational parameters of said functions.

4. The security system of claim 2 wherein activation of said functions further comprises varying the operational parameters of said functions.

5. The security system of claim 1 wherein said control system includes a socket for ease of inserting and removing said activation chip from said system.

6. The security system of claim 2 wherein said control system includes a socket for ease of inserting and removing said activation chip from said system.

7. The security system of claim 1 wherein said activation chip has a read/write capability so that an activation code on said chip can be changed to allow selective activation of various features of said system.

8. The security system of claim 2 wherein said activation chip has a read/write capability so that an activation code on said chip can be changed to allow selective activation of various features of said system.

9. The security system of claim 1 wherein said activation of functions includes activation of latent capabilities of said system.

10. The security system of claim 2 wherein said activation of functions includes activation of latent capabilities of said system.

11. A method for varying the operational parameters of a security system comprising the steps of:
a) providing power to a security system
b) having the system look for an activation chip;
c) reading by the system of codes on the chip;
d) matching the code on the chip with a look up table of codes saved in a memory of the system; and
e) activating features of the security system associated with the matched code.

12. The method of claim 11 wherein the step of activating features includes varying the operational parameters of the system.

13. The method of claim 12 wherein varying the operational parameters includes changing the opening and closing characteristics of a movable barrier of the system that limits access to a restricted area protected by the barrier.

14. The method of claim 13 wherein the step of changing the opening and closing characteristics comprises changing the length of time the barrier remains open after allowing the entry of an entity authorized to enter.

15. The method of claim 12 wherein the step of changing authorization codes for an entities allowed to enter a secure area protected by said security system upon the using a code by the entity to activate opening of a security barrier controlled by the security system.

16. The method of claim 11 wherein the step of activating features of the security system comprises activating latent features of the security system.
